(19) United States
(12) Patent Application Publication
(10) Pub. No.: US 2023/0227378 A1
(43) Pub. Date: Jul. 20, 2023

(54) SMART FERTILIZERS AND METHOD OF MANUFACTURING AND USING THE SAME

(71) Applicants: Huan Manh Nguyen, Ho Chi Minh (VN); Thuan Minh Huynh, Ho Chi Minh (VN); Luong Ngoc Dang, Ho Chi Minh (VN); Quoc Binh Minh Phan, Ho Chi Minh (VN); Luong Huu Nguyen, Ho Chi Minh (VN); Hung My Huynh Nguyen, Ho Chi Minh (VN); Chau Giang Thi Nguyen, Ho Chi Minh (VN); Nhan Van Truong, Ho Chi Minh (VN); Noa Uy Pham Do, Ho Chi Minh (VN); Kim Ngan Thi Nguyen, Ho Chi Minh (VN)

(72) Inventors: Huan Manh Nguyen, Ho Chi Minh (VN); Thuan Minh Huynh, Ho Chi Minh (VN); Luong Ngoc Dang, Ho Chi Minh (VN); Quoc Binh Minh Phan, Ho Chi Minh (VN); Luong Huu Nguyen, Ho Chi Minh (VN); Hung My Huynh Nguyen, Ho Chi Minh (VN); Chau Giang Thi Nguyen, Ho Chi Minh (VN); Nhan Van Truong, Ho Chi Minh (VN); Noa Uy Pham Do, Ho Chi Minh (VN); Kim Ngan Thi Nguyen, Ho Chi Minh (VN)

(73) Assignee: Vietnam Petroleum Institute, Ha Noi (VN)

(21) Appl. No.: 17/821,529

(22) Filed: Aug. 23, 2022

(30) Foreign Application Priority Data
Sep. 28, 2021 (VN) 1-2021-06017

(51) Int. Cl. C05G 3/40; C05G 5/27

(52) U.S. Cl. CPC C05G 3/44; C05G 5/27; B82Y 30/00

(57) ABSTRACT

Smart fertilizers and method of using and manufacturing are provided that include nanocarbon solution mixed with nanocomposite hydrogels at predetermined percentage weight or volume ratio (% w/w or % v/v). The resulted smart fertilizers are characterized in biosensors for detecting electricity conductance (EC) and/or pH degree of the surrounding soil caused by the release of ATPase H⁺ from the plant roots and in bioactuators for chemically reacting with the surrounding hydron ions to release the nutrients once the biodetectors detect the stimuli conditions.

### CLAIM OF PRIORITY

This application claims priority under 35 U.S.C. § 119 of an application No. 1-2021-06017 filed on 28 Sep. 2021 (Sep. 28, 2021) in the Socialist Republic of Vietnam.

### FIELD OF THE INVENTION

The present invention relates generally to the field of fertilizers. More specifically, the present invention relates to the smart delivering fertilizers.

### BACKGROUND ART

Fertilizers play a very important role in increasing the crop output and ensuring food security in many countries. The worldwide use of urea fertilizers has increased more than 100-fold in the past four decades and now constitutes more than 50 percent of global nitrogenous fertilizer usage. However, overuse of urea fertilizers causes problems such as nitrogen leaching, immobilization, denitrification, and ammonia volitization that deplete soil nutrients and degrade the surrounding environment. When fertilizers are applied to the soil to provide micronutrients to the crops, the nutrient cycle occurs in which (a) nitrogen (N₂) are converted into nitrate ions (NO₃⁻) by soil microorganisms called ammonium converging bacteria (ACB) or ag; (b) nitrate ions (NO₃⁻) are transformed into ammonia (NH₄⁺) by the following equation: 2NO₃⁻+20H⁺→2NH₄⁺+6H₂O. When nitrate ions are depleted from the rhizosphere by the leaching action of the run-off water, erosion, detrinification, and/or volatization, the nitrate transformation as specified by the above equation does not happen, excess cations (H+) build up, leading to soil acidification. Acidity also decreases the availability of plant nutrients such as phosphorous (P) and Mobylendum (Mo) and increases the availability of some elements to toxic levels such as aluminum (Al) and Manganese (Mn). In addition, acidity reduces the content of organic matter, humus content, beneficial species (e.g., mycorrhizal fungi and Rhizobia), stunting plant growth, lowering the pH of the soil, growing pests, and even leading to the release of the greenhouse gas and contamination of waterbed. Overall, the overuse of fertilizers will produce the inability to adsorb cations, which means the loss of cation exchange capacity (CEC) in soil. This results in low Nutrient Use Efficiency (NUE) in the use of fertilizers.

To improve the use of fertilizers, different methods have been implemented to avoid the mechanics that denies nutrients availability to plants. One of such methods is the use of organic fertilizers. However, organic fertilizers do not contain sufficient primary nutrients such as nitrogen (N₂), phosphor (P), and potassium (K) for plants. Furthermore, the process of making organic fertilizers is complicated and therefore there are not sufficient organic fertilizers to support large scale agriculture. Another method uses slow and controlled fertilizers. According to this method, fertilizers are encapsulated in polymer coats which are designed to synchronize the release of nutrient according to the nutrient uptakes of the plants. Nutrient uptakes of plants usually follow three main patterns: parabolic release, sigmodal release, and linear release. These polymeric coats such as epoxy resin, polyolefin coated urea (POCU), isobutylidene diurea (IBDU), polyurtherane, aluminosilicates which may be produced using two or more than two precursor compounds. For example, one of the precursor compounds may be isocyanate, diisocyanate, or a polyisocyanate. The benefits of intelligent fertilizers include optimal plant growth and nutrient use efficiency (NUE). That is, intelligent fertilizers have shown to reduce the amount of fertilizer by 30% while keeping crop yields the same. Better understanding of crop cycle, crop type, and their demands of nutrients, the release of nutrient of the intelligent fertilizers match the nutrient uptakes of the plants. Intelligent fertilizers are independent of weather and soil type, thus avoiding the mechanics that decrease the nutrient availability to plants—the processes of nitrification, denitrification, immobilization, leaching, volitization, run-offs, precipitation, exchange, and fixation can be significantly reduced. However, this method requires multiple coating such as first coating a fertilizer with a polymer, then coating the polymer with sulfur, and thereafter applying a polymer coating. These polymers require that the substrate contain a minimum quality of reactive NH₂ groups. Thus, this method is not applicable to all fertilizer compositions for which slow release properties may be desirable. Furthermore, this coating method is expensive and complex to produce and often results in the cracking of the coatings due to abrasion, thus leading to non-synchrony of fertilizers application to plant uptakes and resulting in low Nutrient Use Efficiency (NUE).

Another method, designed to inhibit or retard oxidation of ammonium to nitrate (NO₃), is called nitrification inhibitors. Blending of nitrogen fertilizers with nitrification inhibitors increases their efficiency by reducing nitrification, because nitrates formed on the oxidation of ammonium are easily lost by leaching under upland and denitrification under submerged soil conditions. A large number of chemicals are known to have nitrification inhibiting properties. These include, N-Serve or nitrapyrin [2-chloro-6-(trichloromethyl) pyridine]), DCD (dicyndiamide), AM (2-amino-4-chloro-6-methyl pyrimidine), CMP (1-carbamoyle methylpyrazole), terrazole (etridiazole), CP (2-cyanimino-4-hydroxy-6-methyl pyrimidine), AT/ATc (4 aminotriazole), ST (sulphatiazole or sodium thiosulphate), ATS (ammonium thiosulphate), ZPTA (thiosulphoryl triamide). However, in this nitrification inhibitor method, a large amount of toxic chemicals such as formaldehyde, 2-cyanimino-4-hydroxy-6-methyl pyrimidine was applied to the soils. This may increase toxilogical risk to human after consuming those plants which absorbed such toxic chemicals. In addition, this method required expensive and complex manufacturing processes.

In another attempt to solve the above problems, advanced controlled and slow released fertilizers use nanocarbon such as graphene oxide (GO) sheets in place of polymeric coatings. Graphene oxide sheets provide a high loading of plant micronutrients with controllable slow release. However, using the graphene oxide sheets as carriers of fertilizers are often problematic because of the strong electrostatic and Van der Waals forces between graphene sheets. The Van der Waals interactions cause the sheets to form clusters or tight long bundles that may form a dense and entangled network, causing defects in the graphitic structure. As a result, graphene oxide sheets as fertilizer carrier may often reduce NUE because nanocarbon materials require careful manufacturing and preparing processes to be useful or to be functional.

Therefore what are needed are fertilizers and production method that achieve high NUE, reduce risks to the environment or eco-friendly, and versatile to function with different types of fertilizers.

Yet what are needed are smart fertilizer and production method that are simple, inexpensive, and effective to produce useful (or functional) nanocarbon carriers.

The smart fertilizers and method of manufacturing of the present invention solve the above described problems and meet the long felt needs for fertilizers in in the agriculture sector.

### SUMMARY OF THE INVENTION

Accordingly, an object of the present invention is to provide smart fertilizers and method of using and manufacturing the same that include a nano carbon solution mixed with nanocomposite hydrogels at predetermined percentage weight or volume ratio (% w/w or % v/v). The resulted smart fertilizers are characterized by having biosensors for detecting various endogenous stimuli such as electricity conductance (EC) or salinity, soil pH degree caused by the release of ATPase H⁺ from the plant roots and in bioactuators for chemically reacting with the surrounding hydrogen ions to release the nutrients when the biosensors detect the stimuli conditions.

Another object of the present invention is to provide a process for manufacturing a smart fertilizer that includes (a) functionalizing a nanocarbon solution using vegetable oils and organic solvents; (b) mixing the functionalized nanocarbon solution (fn-NC) with nanocomposite hydrogels; (c) mixing the fn-NC and nanocomposite hydrogel with a selected fertilizer; and (d) drying the fn-NC and nanocomposite hydrogel.

Another object of the present invention is to provide smart fertilizers having biosensors operable to sense stimuli in the surrounding soil and a bioactuators operable to release the fertilizer into the surrounding soil when the stimuli are detected.

Another object of the present invention is to provide a process of using said smart fertilizer comprising: (a) obtaining a smart fertilizer having biosensing and bioactuating capabilities, (b) distributing the smart fertilizer into the soil; (c) detecting an amount of pH or other endogeneous stimuli in the surrounding soil; (d) if the amount of pH/stimuli of the surrounding soil is less than a predetermined pHa, then collapsing said nanocomposite hydrogel to release the fertilizer into the surrounding soil; and (e) otherwise, continue to hold the fertilizer inside the nanocomposite hydrogel.

Yet another object of the present invention is to provide a process for functionalizing nanocarbon solution (fn-NC) which includes (a) heating vegetable oils selected among the group of linseed oils, soybean oils, and sunflower oils having a first predetermined percentage weight or volume (% w/w or % v/v), (b) selecting organic solvents selected among the group of methanol, ethanol, and acetone having a second percentage weight or volume (% w/w or % v/v); (c) selecting nanocarbon solution having a specified characteristics suitable to binding with fertilizers; (d) heating and stirring the selected organic solvent and selected organic solvent at a predetermined temperature and speed for a predetermined time period; (e) dispersing the nano carbon solution into the mixture of organic oils and organic solvents.

Another object of the present invention is to provide a process of manufacturing smart fertilizers that include (a) functionalizing nanocarbon solution by mixing selected nanocarbon material with heated vegetable oils and organic solvents at predetermined percentage weight or volume (% w/w or % v/v); (b) preparing nanocomposite hydrogel; (c) agitating a selected fertilizer at a second predetermined percentage weight or volume (% w/w or % v/v) by an inclined rotating pan; (d spraying the functionalized nanocarbon (fn-NC) solution on the fertilizer at a predetermined spraying rate; and (d) drying the the mixture of fertilizer and nanocarbon solution at a predetermined temperature and time to obtain smart fertilizer.

These and other advantages of the present invention will no doubt become obvious to those of ordinary skill in the art after having read the following detailed description of the preferred embodiments, which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a flowchart illustrating a general process of manufacturing smart fertilizers in accordance with an aspect of the present invention;

FIG. 2 is a flowchart illustrating a detail process of manufacturing the smart fertilizer in accordance with an aspect of the present invention from fresh ingredients;

FIG. 3 is a flowchart illustrating a process of using smart fertilizers in accordance with an aspect of the present invention from powder ingredients;

FIG. 4 shows various diagrams illustrating the functionalization of nanocarbon solution by solvents and vegetable oils and the production of smart fertilizer applicable in agriculture in accordance with an exemplary embodiment of the present invention;

FIG. 5A illustrates different rate of nutrient releases by different fertilizers including regular fertilizers, controlled release fertilizers, and smart fertilizers of the present invention;

FIG. 5B illustrates comparative performances in changing the pH of the soil after distribution of different fertilizers including regular fertilizers, controlled release fertilizers, and smart fertilizers of the present invention;

FIG. 5C illustrates comparative performances in changing the electrical conductivity (or salinity in soil) of different fertilizers including regular fertilizers, controlled release fertilizers, and smart fertilizers of the present invention;

FIG. 6A illustrates comparative instantaneous (transient) responses of urea amount released in soils after distribution in terms of minutes of different fertilizers including regular fertilizers, controlled release fertilizers, and smart fertilizers of the present invention; and

FIG. 6B illustrates comparative steady-state responses of the amount of nitrogen (N) in the soil in terms of days long after distribution of different fertilizers including regular fertilizers, controlled release fertilizers, and smart fertilizers of the present invention

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

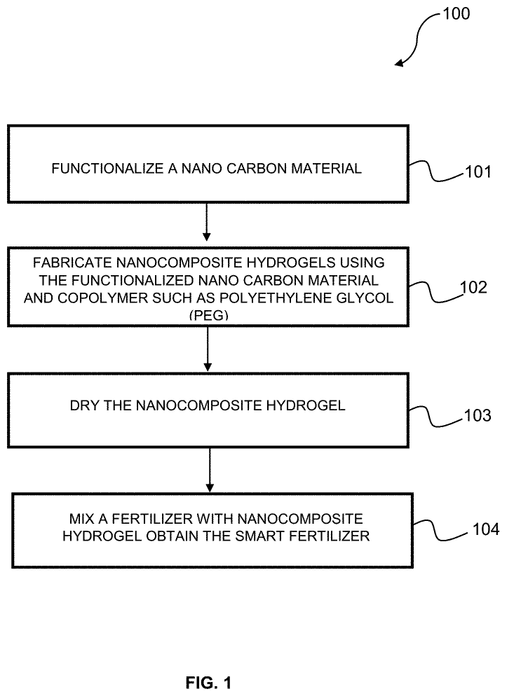

One embodiment of the invention is now described with reference to FIG. 1. FIG. 1 illustrates a process 100 of manufacturing smart fertilizers in accordance with an exemplary embodiment of the present invention.

At step 101, a nanocarbon is functionalized. In many aspects of the present invention, a nanocarbon is first selected, which is characterized by average tube diameter ranging from 3 nm to 50 nm, number of layers from 3 to 45, carbon content from at least 95%. In other aspects, graphene sheets with surface area from 5 to 150 m²/g, 3 to 20 layers, each layer thickness from 5 to 100 nm, and carbon content of at least 95%. The selected nanocarbon having a first predetermined percentage weight or volume is first functionalized by mixing with organic solvent having a second predetermined percentage weight or volume (% w/w or % v/v) and vegetable oils having a third predetermined percentage weight or volume (% w/w or % v/v). Then, organic solvents selected from a group of methanol, ethanol, and acetone is selected at a predetermined percentage weight or volume of 94% to 99%. Vegetable oils selected from linseed oils, soybean oil, and sunflower oil is selected having a predetermined percentage weight or volume of 0.5 to 5%. Step 101 is performed in order to functionalize the selected nanocarbon solution, preventing the nanocarbon materials from bundling up or clustering and rendering them to work well with various chemical functional groups, thus increasing nutrient use efficiency (NUE) of the smart fertilizers.

TABLE 1
Ingredients of Nanocarbon Solution

| No. | Ingredients | Standards |
|---|---|---|
| 1 | Nano carbon | (1) Nano carbon with average tube diameter |
| | solution (0.005 to | from 3 nm to 50 nm, 3-45 layers, carbon |
| | 1 5 (w/w or v/v) | content of at least 95%; |
| | | (2) Graphene sheet: Surface área from 5 to 150 |
| | | m²/g, 3-20 layers, thickness of each layer |
| | | from 5 to 100 nm, and carbón content is at |
| | | least 95%. |
| 2 | Veggetable Oils | Selected from linseed oils, soybean oils, and |
| | 0.5 to 5% (w/w or | sunflower oils. |
| | v/v) | |
| 3 | Organic solvents | Selected from methanol (CH₃OH), ethanol |
| | 94% to 99% (w/w | (C₂H₅OH), and acetone (C₃H₆O) |
| | or v/v) | |

Next, at step 102, a nonocomposite hydrogel is fabricated. In many aspects of the present invention, segmented copolymer polyethylene glycol (PEG) is first obtained by purchasing from Merck. Segmented copolymer and functionalized nanocarbon (fn-NC) were used to prepare the nanocomposite hydrogels at four different nanocarbon contents (0.5, 1.5, 3, and 6 wt % relative to the weight of PEG). In order to embed functionalized nanocarbon homogeneously within the polymer network, the following steps are performed: typically, 0.5 wt % fn-NC sample was prepared by dispersing 1.5 mg of functionalized nanocarbon (fn-NC) in 0.8 mL water and sonication at room temperature for 2 hours. PEG copolymer was dissolved in acetone. Next, the aqueous solution of functionalized nanocarbon was added to the acetone solution of PEG and the resulting blend was mixed thoroughly. Additional water was added, until a liquid gel was formed. At this point, functionalized nanocarbon solution were completely absent from the liquid and incorporated in the liquid gel phase. After blending, the liquid gel was kept in a large amount of deionized water for a day, with water changed several times in order to remove the remaining acetone. In other aspects of the present invention, calcium cross-linked alginate (Ca-Alg) or Bairum alginate (Ba-Alg) are used.

Continuing with step 102, Ca-Alg or Ba-Alg can be easily synthesized in the macroscale level by dropping an alginate solution to a cation-containing aqueous solution that leads to spherical hydrogel beads. Micro- and nano-Alg hydrogels can be obtained by reactions in water-in-oil-in-water emulsions or using microfluidic devices. Ca-Alg hydrogel has been as well electrodeposited on an electrode surface based on the pH-dependent solubility of CaCO3. The hydrogel morphology and shape can be easily tuned to fulfill its intended application.

At step 103, the nanocomposite hydrogel is dried. Step 103 is implemented by drying in an oven at 40° C. for 24 hours.

At step 104, fertilizers of choice is selected to mix with the nanocomposite hydrogel to obtain the smart fertilizers. In various aspects of the present invention, the selected fertilizer is placed in a rotating pan inclined at angle between 30° to 60° rotated at a speed between 10-50 rpm. The inclined pan is heated up between 40° to 60° celcius. The nanocarbon solution obtained from step 101 is sprayed onto the fertilizer at a speed of 0.6 to 1.8 liters/hour until the percentage weight or volume (% w/w or % v/v) of nanocarbon solution to fertilizer between 10% to 30% is reached.

After the mixing of the selected fertilizer and nanocarbon solution is completed, i.e. satisfying the spraying rate and the predetermined percentage of weight or volume ratio (% w/w or % v/v), the final product is dried again at a predetermined temperature and a predetermined time period to achieve the smart fertilizer of the present invention. In many aspects of the present invention, the predetermined temperature is 80° C. and the optimal drying time is 6 to 24 hours.

The process 100 disclosed above achieved the following objectives of the present invention:

Developed a simple and cost effective formulation of smart fertilizer that are eco-friendly, high NUE, and applicable to different types of fertilizers. Within the context of the present invention, high NUE means delivering nutrients according to plants uptakes without loosing nutrients to the environment, and other harmful environmental

Next referring to G. 2, a process 200 of manufacturing a nano carbon solution functionalized with various fertilizers to produce smart fertilizers is presented. In some implementations, process 200 is used to prepare a functionalized nanocarbon solution. In this instant, the nanocarbon solution is ready to be mixed with a diverse type of fertilizers such as urea, potassium, nitrogen, and phosphor (KNP).

At step 201, a selected organic oil having a first predetermined percentage weight or volume (% w/w or % v/v) is heated up to a first predetermined temperature. In various aspects of the present invention, step 201 is implemented with organic oil selected from linseed oils, soybean oils, and sunflower oils having the first predetermined percentage weight or volume of 0.9 to 2.9% w/w or v/v.

At step 202, organic solvents having a second predetermined percentage weight or volume (% w/w or % v/v) is added to the organic oil in step 201 by stirring at a predetermined stirring speed. The organic solvents are selected from a group of methanol (CH₃OH), ethanol C₂H₅OH), and acetone (C₃H₆O) having second predetermined percentage weight or volume (% w/w or v/v) of 94% to 95%. The mixture is heated and stirred at the same time at the temperature of 25° C. to 35° C. from 1 to 2 hours. The stirring speed is between 100 rpm to 500 rpm. In preferred aspect of the present invention, the stirring speed is 300 rpm at the temperature from 25° C. to 35° C. from 1 to 2 hours.

At step 203, the selected nanocarbon materials having a third predetermined percentage weight or volume (% w/w or v/v) is dispersed to the mixture in step 202 at a predetermined dispersing rate to obtain the functionalized nanocarbon (fn-NC) solution. Step 203 is implemented by an ultrasonic probing with 2,000 watts power at room temperature and for 3 to 30 minutes, depending on the total volume of the functionalized nanocarbon (fn-NC) solution. The functionalized nanocarbon (fn-NC) solution is selected in accordance with Table 1 above with a predetermined percentage weight or volume of 0.005 to 1 5% w/w or v/v. In various embodiments of the present invention, titanium oxide nano carbon material (TiO₂) is selected due to their superior hydrophilicity and capillarity.

At step 204, a nanocomposite hydrogel is obtained and mixed with the functionalized carbon nanotute. In many aspects of the present invention, segmented copolymer polyethylene glycol (PEG) is first obtained by purchasing from Merck. Segmented copolymer and functionalized nanocarbon (fn-NC) were used to prepare the nanocomposite hydrogels at four different nanocarbon contents (0.5, 1.5, 3, and 6 wt % relative to the weight of PEG). In order to embed functionalized nanocarbon homogeneously within the polymer network, the following steps are performed: typically, 0.5 wt % fn-NC sample was prepared by dispersing 1.5 mg of functionalized nanocarbon (fn-NC) in 0.8 mL water and sonication at room temperature for 2 hours. PEG copolymer was dissolved in acetone. Next, the aqueous solution of functionalized nanocarbon was added to the acetone solution of PEG and the resulting blend was mixed thoroughly. Additional water was added, until a liquid gel was formed. At this point, functionalized nanocarbon solution were completely absent from the liquid and incorporated in the liquid gel phase. After blending, the liquid gel was kept in a large amount of deionized water for a day, with water changed several times in order to remove the remaining acetone. In other aspects of the present invention, calcium cross-linked alginate (Ca-Alg) or Bairum alginate (Ba-Alg) are used.

In many aspects of the present invention, step 204 is realized by ionotropic alginate hydrogels such as Ca-Alg or Ba-Alg. The synthesis of these ionotropic alginate hydrogels are simple and well-known in the arts, thus it is not discussed in details in the present disclosure. Basically, CA-Alg or Ba-Alg can be easily synthesized in the macroscale level by dropping an alginate solution to a cation-containing aqueous solution that leads to spherical hydrogel beads. Micro and nano alginate hydrogels can be obtained by reactions in water-in-oil-in water emulsions or suing microfluidic devices. In other aspects of step 204, nanocomposite hydrogels synthesized from PEG and nano carbons are used.

Next, at step 205, a selected fertilizer containing necessary nutrients to plants is dried. In many aspects of the present invention, step 205 is implemented by drying the selected fertilizer in a frying pan tilted at 30° to 60°, rotated at 10 to 50 rpm, and heated between 40° C. to 60° C. so that the selected fertilizer is completely submerged in the nanocarbon solution.

At step 206, the fertilizer is mixed with the functionalized nanocarbon solution and nanocomposite hydrogel obtained from step 204 and 205 respectively. The mixing of step 206 is achieved by using an electrical sprayer at a speed of 0.6 to 1.8 liters of functionalized nanocarbon solution per hour until the ratio of functionalized nanocarbon solution to the selected fertilizer is reached 10 to 30% w/w or v/v.

At step 207, the smart fertilizers are dried for a sixth predetermined time period and for a fourth predetermined temperature. In many aspects of the present invention, the predetermined temperature is 80° C. and the optimal drying time is 6 to 24 hours.

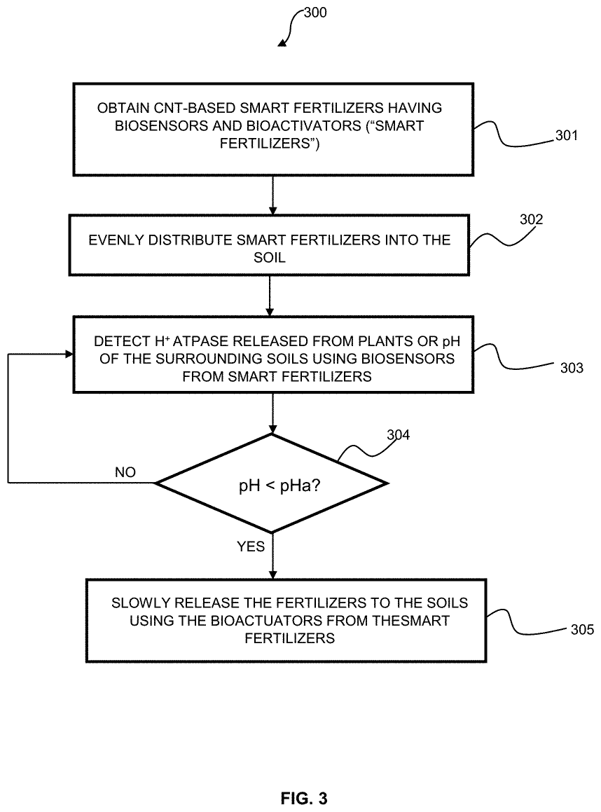

Next referring to FIG. 3, flow chart of a method 300 of use of the smart fertilizer in accordance with an aspect of the present invention is illustrated. Rigorously, method 300 explains the operations of the smart fertilizers obtained from method 100 and 200 above.

At step 301, nanocarbon-based smart fertilizers having biosensing and bioactivating capabilities are obtained. Please refer to method 100 and method 200 above for the implementation of step 301. It is noted that within the scope of the present invention, the preset amount of endogeneous stimuli such as pH, electrical conductivities, biomolecules, or salinities H+ ATPase are set depending on the types of soils and plants. The preset pHa will be set accordingly for the smart fertilizers to be effective because each type of plants and soils have different endogeneous stimuli.

At step 302, the smart fertilizers having biosensing and bioactivating capabilities are distributed evenly in soil and plants that need to be fertilized.

At step 303, the stimuli such as pH of the surrounding soil is detected. Nanocomposite hydrogels are stable in a wide-range of pH<10, but they change structures at pH<pKa due to protonation of the carboxylic groups of the alginate backbone. The protonation of the carboxylic groups changes the gelation since the gel can no longer be supported by electrostatic interactions. As a result, the gel will be sustained by hydrogen bonding between hydroxyl and carboxylic groups of the Nanocomposite hydrogels. Along with pH, other environmental ionic strengths also play an important role on the gel stability. Since the nanocomposite hydrogel is supported by weak electrostatic interactions, the presence of high concentrations of monovalent ions, such as Na+, will promote leakage of cross-linker ions, process that is accompanied by the entrance of water. As a result, the gel can swell and eventually, when not enough cross-linker ions are available for cross-linking, the gel collapses.

At step 304, if the pH stimuli is less than the threshold level, the gel of the smart fertilizer that hold the nutrients or fertilizers collapse and step 305 is performed. Otherwise the gels are still intact holding the release of the fertilizers or nutrients. As such step 303 is repeated until plants release signals for nutrients.

At step 305, fertilizers are slowly delivered to the plants by virtue of the functionalized nano carbon solution and by the collapse of the protecting gels. In many aspects of the present invention, step 305 is enhanced in the presence of cross-linker cation chelating agents, such as citrate and phosphate. Other smart materials such as Ca-Alg and Ba-Alg are characterized for being electrochemically inactive, fully transparent, very stable and highly porous. They become excellent matrixes for developing “smart” materials in which the “smart” or stimuli-responsiveness of the device is granted by other components, such as responsive polymers, enzymes, or nanoparticles that can be encapsulated or functionalized within the alginate hydrogel.

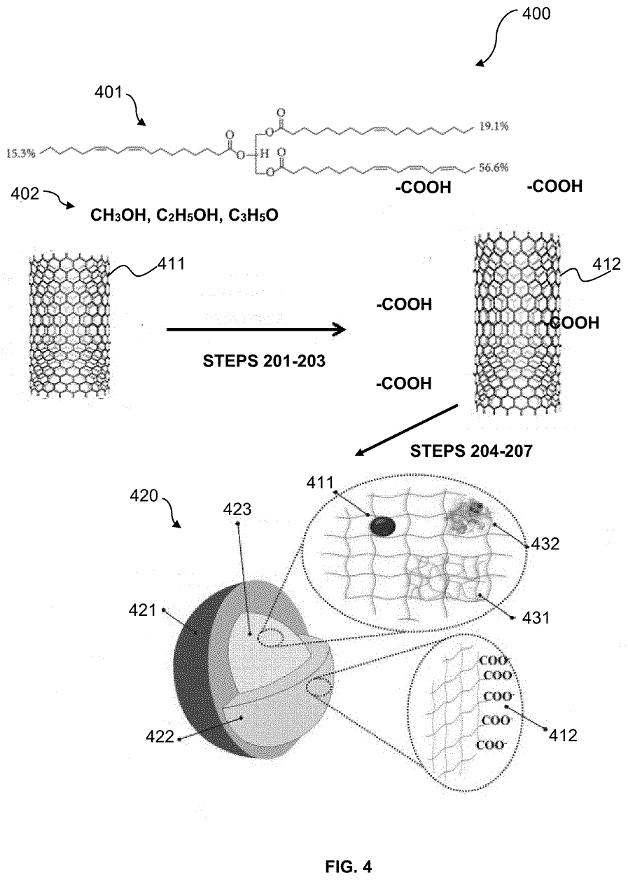

Next referring to FIG. 4, structural diagrams 400 illustrating the functionalization of smart fertilizers characterized in stimulus-responsive and signal triggered fertilizer release capabilities in accordance with exemplary aspects of the present invention are shown. A diagram 401 illustrates a formula of unsaturated fatty acids found in vegetable oils such as linseed oil, soybean oil, and sunflower oil. These vegetable oils contain Ω-3 fatty acid alpha linolenic acid (ALA) when treated with nano carbon materials such as graphene sheets and nano carbon solution will epoxide the nanocarbon materials, increasing the retention of nutrients such as N, K, P from untreated fertilizers. Equivalently, these fatty acids act to slow down the release of the fertilizers (see Tables 2-4). Please refer to step 101, 201, and 301 above.

A diagram 402 illustrates the chemical formulae for (CH₃OH), ethanol C₂H₅OH), and acetone (C₃H₆₀) respectively. These are excellent solvents which can be used to remove unwanted micro impurities from the nano carbon materials. These solvents act to prepare the nano carbon materials to open up the pores and prevent the nano carbon materials from bundling up. Please see step 102, 202, and 302.

A nano carbon material 411 is selected according to percentage weight or volume (% w/w or % v/v), heated up, and stirred (sonification) according to Table 1 and step 101, step 201, and step 301 above. Afterwards, nano carbon material 411 is functionalized according to process 200 and become nano carbon solution 412 with carboxylic acid (—COOH) attached to ft. Functionalization within the scope of the present invention means that the nano carbon materials are prepared without impurities, larger pore volume, and without bundling up, ready to be used with fertilizers. In many aspects of the present invention, the nano carbon solution selected is titanium oxide multi-walled nano carbon solution (TiO₂).

Nano carbon solution 412 of step 203 is undergone process 200 which is mixed with nanocomposite hydrogels at the rate and percentage weight as specified in process 200 to produce smart fertilizer 410 which contain a coating 421, a nanocomposite hydrogel interior 423, a nanocomposite hydrogel exterior 422, a polymer 431, a fertilizer 432 such as urea, DAP, and potassium. The manufacturing and the improved characteristics of nano carbon solution 411 are shown in Examples 1-5 and Tables 2-4 below. Coating 21 are polycations functioning as additional barrier to prevent leakage, increase stability for different functional groups. Nanocomposite hydrogel exterior 421 macroscopically solid, is negatively charged functioning to control mass transport retain the fertilizer payload, Nanocomposite hydrogel interior 422 is 99% liquid functioning as catalysis by liquid like diffusion, Nano carbon solution 411 functioning as scaffolding responding for holding and slow delivery of fertilizer 432. Polymer 431 contained with nanocomposite hydrogels acts to support the scaffolding of nanocarbon 411 that deceases porosity and the de-gelation responsive behavior of the smart fertilizer 420. Surface functionalization 412 which contains carboxylic groups. The protonation of the carboxylic groups changes the gelation since the gel can no longer be supported by electrostatic interactions. As a result, the gel will be sustained by hydrogen bonding between hydroxyl and carboxylic groups of the Nanocomposite hydrogels. Along with pH, other environmental ionic strengths also play an important role on the gel stability. Since the nanocomposite hydrogel is supported by weak electrostatic interactions, the presence of high concentrations of monovalent ions, such as Na+, will promote leakage of cross-linker ions, process that is accompanied by the entrance of water. As a result, the gel can swell and eventually, when not enough cross-linker ions are available for cross-linking, the gel collapses.

### Example 1: Nanocarbon (Graphene) Production with Heated Linseed Oils

In this example, a nanocarbon solution as described in process 200 is functionalized with heated linseed oil was prepared by the following procedure.

Acetone purchased from Xilong in China was used with heated linseed oil purchased from Furniture Clinic in UK to functionalize the graphene. The 99 gram of acetone and 0.9 gram of heated linseed oil were mixed together by stirring at a speed of 300 rpm and at a temperature of 30° C. for an hour. See step 101 and step 201. Then 0.1 gram of graphene with 10 to 20 layers was added to the linseed-acetone solution using a 2000 Watts ultrasonic proble for five minutes at room temperature to obtain the nano carbon solution with an average particle size of 400 nm. See step 102 and step 202 above.

### Example 2: Functionalizing Nano Carbon Solution with Heated Linseed Oils

In this example, a nanocarbon solution as described in process 200 is functionalized with heated linseed oil was prepared by the following procedure.

Acetone purchased from Xilong in China was used with heated linseed oil purchased from Furniture Clinic in UK to functionalize the nano carbon solution. The 99 gram of acetone and 0.9 gram of heated linseed oil were mixed together by stirring at a speed of 300 rpm and at a temperature of 30° C. for an hour. See step 101 and step 201. Then 0.1 gram of nanocarbon solution with 30 to 50 layers was added to the linseed-acetone solution using the 2000 Watts ultrasonic proble for five minutes at room temperature to obtain the nano carbon solution with an average particle size of 600 nm, See step 102 and step 202 above.

### Example 3: Preparing Nanocomposite Hydrogels

A nonocomposite hydrogel was fabricated. In many aspects of the present invention, segmented copolymer polyethylene glycol (PEG) was first obtained by purchasing from Merck. Segmented copolymer and functionalized nanocarbon (fn-NC) were used to prepare the nanocomposite hydrogels at four different nanocarbon contents (0.5, 1.5, 3, and 6 wt % relative to the weight of PEG). In order to embed functionalized nanocarbon homogeneously within the polymer network, the following steps are performed: typically, 0.5 wt % fn-NC sample was prepared by dispersing 1.5 mg of functionalized nanocarbon (fn-NC) in 0.8 mL water and sonication at room temperature for 2 hours. PEG copolymer was dissolved in acetone. Next, the aqueous solution of functionalized nanocarbon was added to the acetone solution of PEG and the resulting blend was mixed thoroughly. Additional water was added, until a liquid gel was formed. At this point, functionalized nanocarbon (fn-NC) were completely absent from the liquid and incorporated in the liquid gel phase. After blending, the liquid gel was kept in a large amount of deionized water for a day, with water changed several times in order to remove the remaining acetone. In other aspects of the present invention, calcium cross-linked alginate (Ca-Alg) or Bairum alginate (Ba-Alg) are used.

Ca-Alg or Ba-Alg was synthesized in the macroscale level by dropping an alginate solution to a cation-containing aqueous solution that led to spherical hydrogel beads. Micro- and nano-Alg hydrogels could obtained by reactions in water-in-oil-in-water emulsions or using microfluidic devices. Ca-Alg hydrogel has been as well electrodeposited on an electrode surface based on the pH-dependent solubility of CaCO3. The hydrogel morphology and shape were tuned to fulfill their intended experiments.

### Example 4: Preparing Smart Urea Fertilizers with Nanocarbons

In this example; a smart urea nano carbon fertilizer as described in process 200 was manufactured by the following procedure.

The urea fertilizer obtained from the Ca Mau Fertilizer company in Vietnam was obtained and stirred in a rotating pan at a speed of 30 rpm. The pan was inclined at 45° and heated to the temperature of 50° C. See step 201. Then, the functionalized nano carbon (fn-NC) solution from either Example 1 or Example 2 above was added with the mass ratio between nano carbon solution and urea fertilizer of 1/10 or 10% w/w. Then the mixture is mixed with using the nanocomposite hydrogel obtained from Example 3 using an electrical sprayer at a speed of 0.6 to 1.8 liters of functionalized nanocarbon solution per hour until the ratio of functionalized nanocarbon solution to the selected fertilizer is reached 10 to 30% w/w or v/v. See step 206. Finally, the urea-nano carbon solution was dried at 80° C. for 12 hours to obtain the smart urea fertilizer. See step 207.

### Example 5: Preparing Smart Dap Fertilizers

In this example, nano carbon DAP fertilizer was manufactured as described in process 300 by the following procedure.

DAP fertilizer with DAP type 46% obtained from Binh Dien company in Vietnam was stirred in a rotating pan at a speed of 30 rpm. The pan was inclined at 45° and heated to the temperature of 50° C. Celcius. See step 201, Then, the nano carbon solution from either Example 1 or Example 2 above was added with the mass ratio between nano carbon solution and urea fertilizer of 1/10 or 10% w/w. See step 202. Finally, the urea-nano carbon solution was dried at 80° C. for 12 hours to obtain the smart DAP fertilizer. See step 203. Then the mixture is mixed with using the nanocomposite hydrogel obtained from Example 3 using an electrical sprayer at a speed of 0.6 to 1.8 liters of functionalized nanocarbon solution per hour until the ratio of functionalized nanocarbon solution to the selected fertilizer is reached 10 to 30% w/w or v/v. See step 206. Finally, the urea-nano carbon solution was dried at 80° C. for 12 hours to obtain the smart urea fertilizer. See step 207.

### Example 6: Preparing Smart Potassium (K) Fertilizers

In this example, potassium nano carbon fertilizer was manufactured as described in process 300 by the following procedure.

Potassium fertilizer of type K20 61% obtained from Phu My Fertilizer company in Vietnam was stirred in a rotating pan at a speed of 30 rpm. The pan was inclined at 45° and heated to the temperature of 50° C. Celcius. See step 201. Then, the nano carbon solution from either Example 1 or Example 2 above was added with the mass ratio between nano carbon solution and the potassium fertilizer of 1/10 or 10% w/w. See step 202. Finally, the potassium nano carbon solution was dried at 80° C. for 12 hours to obtain the smart potassium nano carbon fertilizer. See step 203. Then the mixture is mixed with using the nanocomposite hydrogel obtained from Example 3 using an electrical sprayer at a speed of 0.6 to 1.8 liters of functionalized nanocarbon solution per hour until the ratio of functionalized nanocarbon solution to the selected fertilizer is reached 10 to 30% w/w or v/v. See step 206. Finally, the urea-nano carbon solution was dried at 80° C. for 12 hours to obtain the smart urea fertilizer. See step 207.

### Smart Fertilizers Water Solubility Experiments

In this experiment, the water solubility and the concentration of NPK of the smart fertilizers obtained from Examples 3,4, and 5 (Urea, DAP, and potassium) of the present invention were studied and compared with commercially available fertilizers.

The experiments were performed in the following steps

Step 1: Distilled water of the equal volume of 40 mL were used in two cups.

Step 2: Obtaining regular urea, DAP, and potassium fertilizers each having a weight of 1.5 g was poured into one cup of distilled water above. Urea, DAP, and potassium smart fertilizers obtained in Examples 3,4, and 5 above in accordance with process 200 and process 300 having the same weight of 1.5 g was poured into the second cup of distilled water.

Step 3: Observed and record the time of complete dissolution of the two types of fertilizers under test from the two cups of distilled water. The nitrogen content according to TCVN 2620-2014, the potassium content according to TCVN 8562-2010, and potassium content according to TCVN 8563-2010 were also observed and recorded in the following Tables.

TABLE 2
Water Solulibity and Nutrient Contents of Urea Fertilizers

| | | Time of | Nutrient |
|---|---|---|---|
| | | Complete | Content in |
| Fertilizer | | Soluble | Water After |
| Sample | Contents | in Water | Dissolution |
| Sample 0 | Regular Urea | 5 minutes | 1.67% kl |
| | Fertilizer | | |
| Sample 1 | Smart Urea Fertilizer | 15 minutes | 0.26% kl |
| | of Process 100, 200, | | |
| | and 300 and | | |
| | Implemented as | | |
| | specified in Example | | |
| | 1 | | |
| Sample 2 | Smart Urea Fertilizer | 7 minutes | 1.26% kl |
| | of Process 100, 200, | | |
| | and 300 and | | |
| | Implemented as | | |
| | specified in Example | | |
| | 1 | | |

TABLE 3
Water Solulibity and Nutrient Contents of DAP Fertilizers

| | | Time of | Nutrient |
|---|---|---|---|
| | | Complete | Content in |
| Fertilizer | | Soluble | Water After |
| Sample | Contents | in Water | Dissolution |
| Sample 0 | Regular DAP | 2 hours | 0.97% kl |
| | Fertilizer | | |
| Sample 1 | Smart DAP Fertilizer | 4 hours | 0.05% kl |
| | of Process 100, 200, | | |
| | and 300 and | | |
| | Implemented as | | |
| | specified in Example | | |
| | 1 | | |
| Sample 2 | Smart DAP Fertilizer | 2 hours | 0.6% kl |
| | of Process 100, 200, | 30 minutes | |
| | and 300 and | | |
| | Implemented as | | |
| | specified in Example | | |
| | 2 | | |

TABLE 4
Water Solulibity and Nutrient Contents of Potassium Fertilizers

| | | Time of | Nutrient |
|---|---|---|---|
| | | Complete | Content in |
| Fertilizer | | Soluble | Water After |
| Sample | Contents | in Water | Dissolution |
| Sample 0 | Regular potassium | 1 hour and | 1.92% kl |
| | Fertilizer | 30 minutes | |
| Sample 1 | Smart potassium | 3 hours | 0.36% kl |
| | Fertilizer of Process | | |
| | 100, 200, and 300 | | |
| | and Implemented as | | |
| | specified in Example | | |
| | 1 | | |
| Sample 2 | Smart potassium | 2 hours | 1.5% kl |
| | Fertilizer of Process | | |
| | 100, 200, and 300 | | |
| | and Implemented as | | |
| | specified in Example | | |
| | 1 | | |

From the experiment and results above, urea, DAP, and potassium fertilizers coated with nano carbon solution according to process 100, 200, and 300 of the present invention have slower water solubility than the corresponding regular fertilizers available in the market. In addition, the nutrient contents of the smart fertilizers of the present invention detected in the water of test cup were lower than those of the corresponding regular fertilizers without being treated with the nano carbon solutions of the process 200 of the present invention.

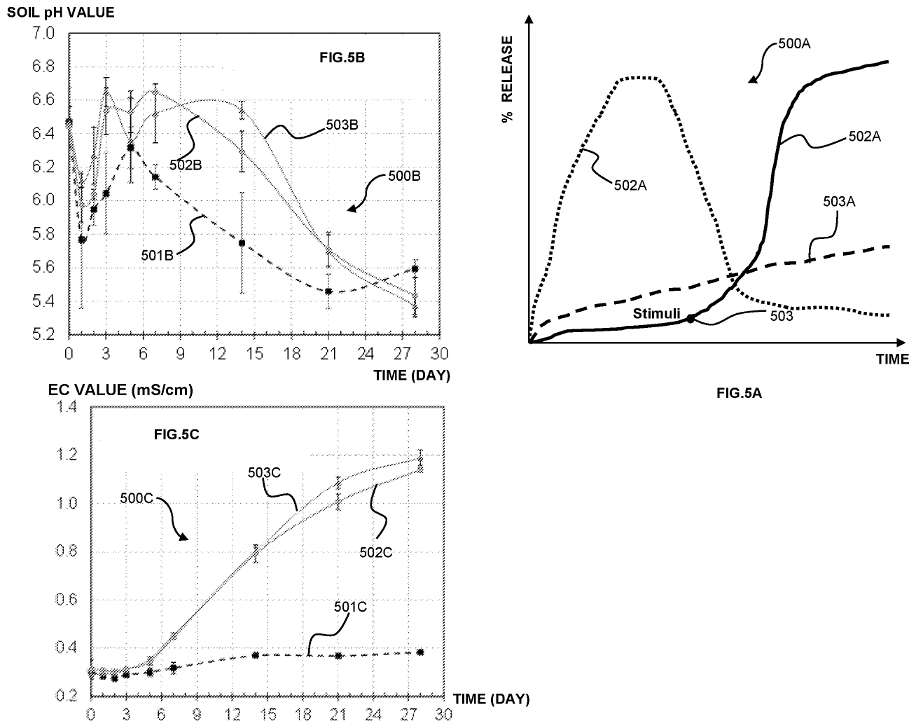

Next, referring to FIG. 5A, a graph 500A comparing the release rates (% release) of three different fertilizers including the smart fertilizers of the present invention is illustrated. A graph 501A of a regular urea fertilizer shows that without any controlled releasing mechanism, the rate of release increases quickly after distribution and then quickly run out and drop sharply. A graph 502A of the smart fertilizer of the present invention at first release the urea fertilizer slowly. When the pH of the surrounding soil or amount of H+ released by the plants surpasses the threshold level, which is a stimuli point 503, the rate of release increases sharply. Please refer back to FIG. 3 and FIG. 4 above for detailed operating principles of the smart fertilizers of the present invention. Other controlled release fertilizers such as Camau translucent bead fertilizers are presented by a graph 503A. Graph 503A increases slowly regardless of the conditions of the plants and the surrounding sons.

### Experiments on Nutrient Release Behaviors, Performances, and NPK Nutrients Mobilities of Different Fertilizers Including the Smart Fertilizers Having Biosensor and Bioacutator Capabilities.

### Example 7: Nutrient Release Behaviors

These experiments were a cooperation between Can Tho University and the Vietnam Petroleum institution).

These experiments were performed and analyzed at room temperature in the Laboratory of Chemistry, Physics, and Soil Fertility, Department of Soil Science, Faculty of Agriculture, Can Tho University.

The soil for these experiments was collected (0-20 cm) in Thuan Hung Ward, Thot Not District, Can Tho Province. The sample belongs the alluvial soils along riverbanks and they have some basic properties shown in Table 5 below.

TABLE 5
Various Tests for Three Different Fertilizers

| Standards | Unit | Values | Evaluation |
|---|---|---|---|
| pHe | — | 4.96 | Average Sour |
| ECe | mS/cm | 0.62 | Not salty |
| CEC | meq/100 g | 17.1 | Average |
| Phosphor Total | % P₂O₅ | 0.46 | Rich in P |
| HC Materials | % C | 2.64 | Low |
| Relative K⁺ | meq K⁺/100 g | 0.83 | High |
| Relative Ca²⁺ | meq Ca⁺⁺/100 g | 7.84 | High |

After collection, the soil was removed of any garbage, roots, and plants residues. It was cleaned and filtered using a 2.0 mm rails to achieve uniform size. Every 200 gram of this soil was stored in a plastic container. 40 ml of distilled water was added to each plastic container. Then, the hydrated soil was left overnight so that the water could thoroughly filtrate the soil. Then the wet soil is mixed again and 10 mL of water was added until the moisture inside the plastic contain reached 30-30% by weight. The plastic containers were closed tightly to trap the water inside, avoiding evaporation of the water.

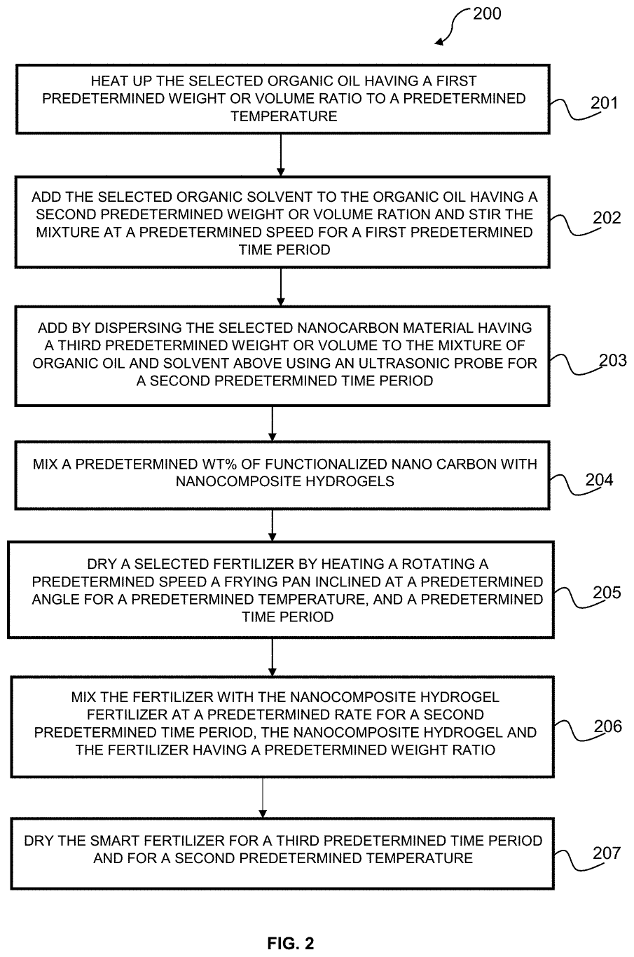

The Camau translucent bead fertilizer manufactured by the Ca Mau Petroleum Fertilizer Company has the nitrogen content of 46.3% was selected. Smart fertilizer of the present manufactured by the Vietnam Petroleum Institute (VPI). The smart fertilizers were selected with synthesized in the VPI lab with a nitrogen content of 46%. The outer layer of nanocomposite film was less than 1% for each pellet. Please refer to FIG. 1 to FIG. 4 above.

TABLE 6
Test Samples on Different Soil Subjects

| Test Trials | Description of Soil Subject | Notes |
|---|---|---|
| NT1 | 1. Alluvial Soil Without Urea Fertilizer | Soil without |
| | | Fertilizer |
| NT2 | 2. Alluvial Soil with Camau Translucent | Content: 46.3% |
| | Beads Fertilizers | Nitrogen (N) |
| NT3 | 3. Alluvial Soil with Smart Fertilizer | Conent 46.0% |
| | | Nitrogen (N) |

Soils in the plastic containers with the same 30-33% moisture suitable for cultivation of different plants determined by field hydrolysis were used for these experiments. The urea pellets were selected to have uniform 2-4 mm in size and weight of 220 mg/200 g of fertilizer with about 6-8 pellets of each type of fertilizers. This amount of N urea is three times higher than that of 150 kg of N/ha that farmers use in the Mekong Delta. The pellets including smart fertilizers 420 described above were burred in the plastic containers containing the moist alluvial soils described above to the depth of 2 mm. Then these plastic containers were tightly lidded to avoid evaporation of water moisture. The plastic containers were numbered and recorded the time of test. Then, these plastic containers were kept in a dark areas in a incubator or the like at room temperature between 27-32° C. The humidity inside each plastic container was constantly checked to keep the moisture at 30-33% at all times.

The soil samples in numbered plastic containers were collected in two phases. Phase 1: immediately after the first day of fertilizer distribution as described in step 301 above. This is also known as transient responses of different fertilizers. In phase 1, the soil samples were collected at 15 minutes, 30 minutes, 120 minutes, 240 minutes, and 360 minutes. Phase 2: time duration was determined to be 0 day, 1 day, 2 days, 3, days, 5 days, 7 days, 14 days, 21 days, and 28 days after distribution of step 301. At each sampling period, the soils in different plastic containers were thoroughly mixed and weighed again in accordance to a fixed procedure. Particularly, for plastic containers that contain slow-released fertilizers, any remaining nanocarbon layers in black colors were removed before samples were taken and mixing. Phase 2 is known as the steady-state responses of the fertilizers.

Standards for Analyses and Evaluation of the Fertilizers.

The standards for analyses and evaluation were carried out in Phase 1 and Phase 2 described above included the pH of soils, Electricity Conductance or Salinity, Amount of N Urea in Soils for transient and steady-state responses.

The following analyses were studied among different fertilizers.

The Changes in pH of the Soils

TABLE 6
Changes in the pH of the Soils

| | Amount of urea-N (mg/kg) | | | | |
|---|---|---|---|---|---|
| Soil Samples | Day 0 | Day 1 | Day 2 | Day 3 | Day 5 |
| 1. Soil Without Fertilizer | 6.47 ± 0.21 | 5.77 ± 0.41 | 5.95 ± 0.09 | 6.04 ± 0.24 | 6.32 ± 0.12 |
| 2. Soil with Camau Translucent | 6.47 ± 0.10 | 6.12 ± 0.04 | 6.27 ± 0.17 | 6.65 ± 0.09 | 6.36 ± 0.25 |
| Fertilizer Beads (N CaMau) | | | | | |
| 3. Smart Fertilizer 420 | 6.44 ± 0.12 | 5.98 ± 0.10 | 6.04 ± 0.03 | 6.54 ± 0.14 | 6.53 ± 0.12 |

| | Day 7 | Day 14 | Day 21 | Day 28 |
|---|---|---|---|---|
| 1 .Soil Without Fertilizer | 6.14 ± 0.07 | 5.75 ± 0.30 | 5.46 ± 0.10 | 5.59 ± 0.05 |
| 2. Soil with Camau Translucent | 6.52 ± 0.18 | 6.54 ± 0.05 | 5.70 ± 0.10 | 5.37 ± 0.07 |
| Fertilizer Beads (N CaMau) | | | | |
| 3. Smart Fertilizer 420 | 6.65 ± 0.00 | 6.30 ± 0.12 | 5.71 ± 0.10 | 5.43 ± 0.11 |

Notes:
± standard deviation, n = 3

Referring now to FIG. 5B, graphs 500B comprised of soil pH graphs 501B of standard solid without any fertilizer, a graph 502B of smart fertilizer 420, and a graph 503B of the Camau fertilizer (Camau translucent fertilizer beads) are presented to show different changes in the pH of different soils in plastic containers and test procedure described above. Graph 501B of soil without fertilizer showed that the pH in the soil (inside one plastic container) was fluctuated a lot from 0 day to 27 days, while graph 502B of smart fertilizer 420 showed more steady pH during the time of release as the pH dipped below 6. After that, the pH in soil continued to drop due to all the fertilizers contained therein were exhausted. This experiment helps farmers to understand their land and their crops. Graph 503B of the Camau fertilizer showed more fluctuations in pH of the soil in the first 9 days. Thus, graph 502B was most stable and if sufficient smart fertilizers were used, graph 502B would be more stable and plateau after 10-15 days.

Changes in Salinity of Soils (EC1:2.5) after the Distribution of Fertilizers in Different Plastic Containers

TABLE 8
Changes in Salinities of Soils

| | Amount of Nitrogen in Urea -N (mg/kg) | | | | |
|---|---|---|---|---|---|
| Soil Samples | Day 0 | Day 1 | Day 2 | Day 3 | Day 5 |
| 1. Standard Soil (Soils without | 0.31 ± 0.02 | 0.28 ± 0.01 | 0.28 ± 0.01 | 0.29 ± 0.01 | 0.30 ± 0.02 |
| urea) | | | | | |
| 2. Soil with Camau Translucent | 0.29 ± 0.00 | 0.30 ± 0.01 | 0.30 ± 0.01 | 0.31 ± 0.00 | 0.35 ± 0.01 |
| Fertilizer Beads (N Cà Mau) | | | | | |
| 3. Smart Fertilizer 420 | 0.31 ± 0.04 | 0.31 ± 0.00 | 0.30 ± 0.01 | 0.32 ± 0.00 | 0.34 ± 0.01 |

| | Day 7 | Day 14 | Day 21 | Day 28 |
|---|---|---|---|---|
| 1. Standard Soil (Soils without | 0.32 ± 0.02 | 0.37 ± 0.00 | 0.37 ± 0.00 | 0.38 ± 0.01 |
| urea) | | | | |
| 2. Soil with Camau | 0.45 ± 0.01 | 0.80 ± 0.02 | 1.09 ± 0.02 | 1.19 ± 0.03 |
| Translucent Fertilizer Beads | | | | |
| (N Cà Mau) | | | | |
| 3. Smart Fertilizer 420 | 0.45 ± 0.01 | 0.79 ± 0.04 | 1.01 ± 0.03 | l.14 ± 0.01 |

Notes:
± standard deviation, n = 3

Referring to FIG. 5C, a graph 500C indicating different salinities in soils after different fertilizers were used. A graph 501C representing the salinity of soil without any fertilizer is shown. Graph 501C shows that there was no changes in salinity of soil without fertilizers. The salinity slightly changed due to slight moisture change in the plastic container. A graph 502C representing salinity of soils treated with smart fertilizer 420 of the present invention. After stimulus 503, smart fertilizer 420 responses by releasing nitrogen urea into the soil, changing the salinity of the soil. A graph 403C shows the salinity of soil treated with Camau fertilizer. Again, Camau fertilizer changed the salinity of the surrounding soil in the plastic container after 5 days and continued to rise higher than that of smart fertilizer 420 because it had no controlled mechanism to slow the release of nitrogen fertilizer.

Propensities of Nitrogen-Urea Release Results

TABLE 9
Transient Responses of Nitrogen Urea Release

| | Amount of urea-N (mg/kg) | | | | |
|---|---|---|---|---|---|
| | | 30 | 120 | 240 | 360 |
| Soil Samples | 15 minutes | minutes | minutes | minutes | mintues |
| 1. Standard Soil (Soils without | 71.7 ± 10.0 | 487.1 ± 100 | 447.2 ± 200 | 725.3 ± 175 | 376.l ± 300 |
| urea) | | | | | |
| 2. Soil with Camau Translucent | 384.7 ± 150.5 | 5632.5 ± 350 | 3488.8 ± 160 | 2115.0 ± 250 | 1146.9 ± 200 |
| Fertilizer Beads (N Cà Mau) | | | | | |
| 3. Smart Fertilizer 420 | 105.4 ± 80.0 | 525.3 ± 150 | 827.9 ± 150 | 862.7 ± 200 | 1128.5 ± 150 |

Notes:
± standard deviation, n = 3

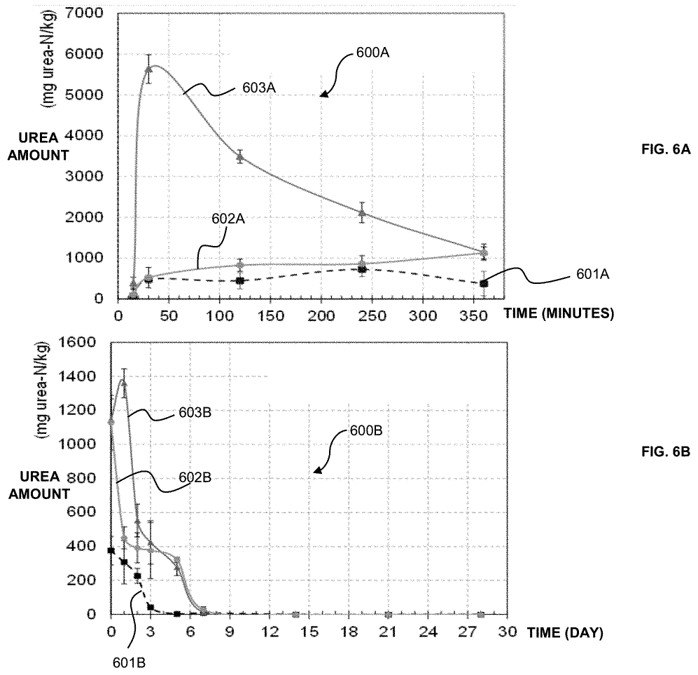

Next referring to FIG. 6A, graphs 600A presenting transient responses of Nitrogen Release of different fertilizers are shown. A graph 601A of the transient response of the soil in the plastic container without any fertilizer shows that the amount of nitrogen did not change. A graph 602A of the transient response of the soil treated with smart fertilizer 420 in the plastic container shows that the amount of nitrogen slightly changed because of the controlled release of the biosensor and bioactuator of smart fertilizer. In the meantime, in the plastic container that contained the soil treated with Camau fertilizer, the amount of nitrogen in urea were quickly released and increasing sharply showing no controlled release. This is shown in a graph 603A.

TABLE 10
Steady-State Responses of Nitrogen Urea Release

| | Amount of Nitrogen in Urea (mg/kg) | | | | |
|---|---|---|---|---|---|
| Soil Samples | Day 0 | Day 1 | Day 2 | Day 3 | Day 5 |
| 1. Standard Soil (Soils without | 376.1 ± 83.2 | 307.6 ± 127.l | 226.5 ± 43.8 | 41.9 ± 9.3 | 3.3 ± 3.1 |
| urea) | | | | | |
| 2. Soil with Camau | 1146.9 ± 121.6 | 1359.9 ± 85.4 | 552.1 ± 95.9 | 423.6 ± 127.6 | 277.4 ± 48.1 |
| Translucent Fertilizer Beads | | | | | |
| (N Cà Mau) | | | | | |
| 3. Smart Fertilizer 420 | 1128.5 ± 160.6 | 450.7 ± 65.10 | 391.6 ± 88.3 | 376.2 ± 164.3 | 321.5 ± 15.5 |

| | Day 7 | Day 14 | Day 21 | Day 28 |
|---|---|---|---|---|
| 1. Standard Soil (Soils without | 8.7 ± 5.10 | 0.0 | 0.0 | 0.0 |
| urea) | | | | |
| 2. Soil with Camau | 13.2 ± 12.9 | 0.0 | 0.0 | 0.0 |
| Translucent Fertilizer Beads | | | | |
| (N Cà Mau) | | | | |
| 3. Smart Fertilizer 420 | 27.6 ± 17.1 | 0.0 | 0.0 | 0.0 |

Notes:
±: standard deviation, n = 3

Finally, referring to FIG. 6B, graphs 600B graphs 600A presenting steady-state responses of Nitrogen Release of different fertilizers are shown. A graph 601B of the steady-state response of the soil in the plastic container without any fertilizer shows that the amount of nitrogen decreased sharply after 3 days. A graph 602A of the state response of the soil treated with smart fertilizer 420 in the plastic container shows that the amount of nitrogen remained constant from day 3 to day 6 because of the controlled release of the biosensor and bioactuator of smart fertilizer. In the meantime, in the plastic container that contained the soil treated with Camau fertilizer, the amount of nitrogen in urea kept dressing from day 1 to day 30 showing no controlled release. This is shown in a graph 603B.

Other test results are presented below.

Amount of NH4⁺-N Released into the Soils

TABLE 11
Steady-State Responses of NH4⁺ Releases of Different Fertilizers

| | Amount of NH₄⁺-N (mg/kg) | | | | |
|---|---|---|---|---|---|
| Soil Samples | Day 0 | Day 1 | Day 2 | Day 3 | Day 5 |
| 1. Standard Soil (Soils without | 7.58 ± 1.62 | 10.4 ± 1.53 | 22.7 ± 0.75 | 20.8 ± 2.18 | 17.2 ± 1.73 |
| urea) | | | | | |
| 2. Soil with Camau | 13.8 ± 0.92 | 39.2 ± 0.48 | 70.8 ± 8.13 | 152.8 ± 4.06 | 247.1 ± 4.60 |
| Translucent Fertilizer Beads | | | | | |
| (N Cà Mau) | | | | | |
| 3. 3. Smart Fertilizer 420 | 15.1 ± 1.84 | 44.6 ± 2.08 | 78.0 ± 6.25 | 154.7 ± 18.8 | 244.3 ± 19.9 |

| | Day 7 | Day 14 | Day 21 | Day 28 |
|---|---|---|---|---|
| 1. Standard Soil (Soils without | 13.3 ± 0.99 | 1.70 ± 1.38 | 0.33 ± 0.57 | 1.49 ± 0.95 |
| urea) | | | | |
| 2. Soil with Camau | 518.3 ± 56.3 | 345.9 ± 26.5 | 213.2 ± 61.6 | 191.4 ± 18.7 |
| Translucent Fertilizer Beads | | | | |
| (N Cà Mau) | | | | |
| 3. Smart Fertilizer 420 | 476.4 ± 21.4 | 292.1 ± 29.5 | 185.4 ± 43.3 | 158.2 ± 16.1 |

Notes
± standard deviation, n = 3

Amount of Nitrate (NO3-N) Release into the Soils

Steady-State Responses of NO₃⁺ Releases of Different Fertilizers

| | Amount of NO₃⁻-N (mg/kg) | | | | |
|---|---|---|---|---|---|
| Soil Samples | Day 0 | Day 1 | Day 2 | Day 3 | Day 5 |
| 1. Standard Soil (Soils without | 26.0 ± 0.77 | 33.9 ± 1.41 | 31.4 ± 1.19 | 36.5 ± 0.69 | 32.8 ± 2.30 |
| urea) | | | | | |
| . 2. Soil with Camau | 34.0 ± 0.93 | 36.3 ± 0.82 | 31.0 ± 0.50 | 44.6 ± 2.39 | 38.3 ± 4.04 |
| Translucent Fertilizer Beads | | | | | |
| (N Cà Mau) | | | | | |
| 3. Smart Fertilizer 420 | 29.6 ± 0.26 | 34.4 ± 1.69 | 32.9 ± 3.72 | 39.7 ± 0.91 | 39.7 ± 2.45 |

| | Day 7 | Day 14 | Day 21 | Day 28 |
|---|---|---|---|---|
| 1. Standard Soil (Soils without | 45.5 ± 2.40 | 48.7 ± 2.68 | 60.5 ± 6.30 | 65.7 ± 3.11 |
| urea) | | | | |
| . 2. Soil with Camau | 70.7 ± 4.04 | 225.4 ± 3.53 | 394.8 ± 4.05 | 342.7 ± 19.2 |
| Translucent Fertilizer Beads | | | | |
| (N Cà Mau) | | | | |
| 3. Urea-CRF (boc nanocarbon) | 62.5 ± 2.45 | 212.0 ± 19.9 | 382.1 ± 30.8 | 340.6 ± 9.44 |

Notes:
± standard deviation, n = 3

### Industry Application of the Smart Fertilizers

The present invention provides a nano carbon solution functionalized according to process 200 and 300 to use with various fertilizers such as urea, DAP, and potassium to achieve unexpected and improved performances (please refer to Table 2, Table 3, and Table 4).

The present invention also provides processes for manufacturing smart fertilizer by using nano carbon solution by process 200 which can be used in agriculture with a much slower nutrient dispersion than corresponding fertilizers without being treated with the functionalized nano carbon solution.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

### REFERENCES

1. Trenkel, M. E., “Slow-and Controlled-Release and Stabilizers: An Option for Enhancing Nutrient Use Efficiency in Agriculture”. International Fertilizer Industry Association (IFA) Paris, France, 2010.
2. Zhang et al., “Slow-release Fertilizer Encapsulated by Graphene Oxide Films” Chemical Engineering Journal, p. 255, 2014.
3. Kabiri et al., “Graphene Oxide a New Carrier for Slow Release of Plant Micronutrients”, ACS Applied Materials & Interfaces, 9(49), 2017.
4. Bhunia, A. K., Johnson, M., and Ray, B. (1987). Direct detection of an antimicrobial peptide of Pediococcus acidilactici in sodium dodecyl sulfate-polyacrylamide gel electrophoresis. Journal of Industrial Microbiology 2(5), 319-322.
5. Chen, C., Sebranek, J. G., Dickson, J. S., and Mendonca, A. F. (2005). Combining Pediocin (ALTA™ 2341) with Thermal Pasteurization for Control of Listeria monocytogenes on Frankfurters. Animal Industry Report 651(1), 62.
6. Grantham, R., Gautier, C., and Gouy, M. (1980). Codon frequencies in 119 individual genes confirm consistent choices of degenerate bases according to genome type. Nucleic acids research 8(9), 1893-1912.
7. Gratia, A., and Fredericq, P. (1946). * DIVERSITE DES SOUCHES ANTIBIOTIQUES DE B-COLI ET ETENDUE VARIABLE DE LEUR CHAMP DACTION. COMPTES RENDUS DES SEANCES DE LA SOCIETE DE BIOLOGIE ET DE SES FILIALES 140(11), 1032-1033.
8. Halami, P. M., and Chandrashekar, A. (2007). Heterologous expression, purification and refolding of an anti-listerial peptide produced by Pediococcus acidilactici K7. Electronic Journal of Biotechnology 10. doi: 10.2225/vol10-issue4-fulltext-11.
9. Henderson, J. T., Chopko, A. L., and van Wassenaar, P. D. (1992). Purification and primary structure of pediocin PA-1 produced by Pediococcus acidilactici PAC-1.0. Arch Biochem Biophys 295(1), 5-12.
10. Line, J., Svetoch, E., Eruslanov, B., Perelygin, V., Mitsevich, E., Mitsevich, I., et al. (2008). Isolation and purification of enterocin E-760 with broad antimicrobial activity against gram-positive and gram-negative bacteria. Antimicrobial agents and chemotherapy 52(3), 1094-1100.
11. Mandal, B., Chowdhury, R., and Jee, C. B. (2014). Purification and characterization of pediocin produced by Pediococcus acidilactici ncim 2292 International Journal of Pharmacy and Pharmaceutical Science 6(6), 5.
12. Messaoudi, S., Kergourlay, G., Rossero, A., Ferchichi, M., Prévost, H., Drider, D., et al. (2011). Identification of lactobacilli residing in chicken ceca with antagonism against Campylobacter. International Microbiology 14(2), 103-110.
13. Moon, G. S., Pyun, Y. R., and Kim, W. J. (2006). Expression and purification of a fusion-typed pediocin PA-1 in Escherichia coli and recovery of biologically active pediocin PA-1. Int J Food Microbiol 108(1), 136-140. doi: 10.1016/j.ijfoodmicro.2005.10.019.
14. Nakamura, Y., Gojobori, T., and Ikemura, T. (1999). Codon usage tabulated from the international DNA sequence databases; its status 1999. Nucleic acids research 27(1), 292-292.
15. Navratilova, P., Vyhnalkova, J., Vorlova, L., and JEŘÁBKOVÁ, J. (2014). A Plate Diffusion Method for Detecting Fluoroquinolone Residues in Raw Cow's Milk. Czech Journal of Food Science 32(3).
16. Nazef, L., Belguesmia, Y., Tani, A., Prévost, H., and Drider, D. (2008). Identification of lactic acid bacteria from poultry feces: evidence on anti-Campylobacter and anti-Listeria activities. Poultry Science 87(2), 329-334.
17. Schoeman, H., Vivier, M. A., Du Toit, M., Dicks, L. M., and Pretorius, I. S. (1999). The development of bactericidal yeast strains by expressing the Pediococcus acidilactici pediocin gene (pedA) in Saccharomyces cerevisiae. Yeast 15(8), 647-656. doi: 10.1002/(SICI)1097-0061(19990615)15:8<647::AID-YEA409>3.0.CO; 2-5.
18. Sinclair, G., and Choy, F. Y. (2002). Synonymous codon usage bias and the expression of human glucocerebrosidase in the methylotrophic yeast, Pichia pastoris. Protein expression and purification 26(1), 96-105.
19. Venema, K., Chikindas, M. L., Seegers, J., Haandrikman, A. J., Leenhouts, K. J., Venema, G., et al. (1997). Rapid and efficient purification method for small, hydrophobic, cationic bacteriocins: purification of lactococcin B and pediocin PA-1. Applied and environmental microbiology 63(1), 305-309.

What is claimed is:

1. A smart fertilizer capable of biosensing pH of surrounding soil and bioactuating to release fertilizers into said surrounding soil, comprising:
a vegetable oil having a first percentage weight (% w);
a solvent having a second percentage weight (% w);
a nanocarbon material having a third percentage weight (% w); and
a nanocomposite hydrogel having a fourth percentage weight (% w).

2. The smart fertilizer of claim 1 wherein said vegetable oil is a linseed oil.

3. The smart fertilizer of claim 1 wherein said vegetable oil is a soybean oil.

4. The smart fertilizer of claim 1 wherein said vegetable oil is a sunflower oil.

5. The smart fertilizer of claim 1 wherein said solvent is methanol.

6. The smart fertilizer of claim 1 wherein said solvent is ethanol.

7. The smart fertilizer of claim 1 wherein said solvent is acetone.

8. The smart fertilizer of claim 1 wherein said nanocarbon material is a carbon nanotube characterized by a plurality of nanotubes having a diameter ranged from 3 nm to 50 nm, by a plurality of layers ranged from 3 to 45 layers, and by a carbon content of at least 95%.

9. The smart fertilizer of claim 1 wherein said nanocarbon material is a graphene sheet characterized by having a carbon content of at least 95%, a surface area ranged from 5 to 150 m²/g, at least 3 to 20 layers; wherein each layer has a thickness ranged from 5 nm to 100 nm.

10. The smart fertilizer of claim 1 wherein said nanocarbon material is nano carbon particle having a particle size ranged from 300 nm to 600 nm, preferably 400 nm to 550 nm.

11. The smart fertilizer of claim 1 wherein first percentage weight (% w) is between 0.5% to 5%, said second percentage weight (% w) is between 94% to 99%, and said third percentage weight is between 0.005% to 1%.

12. A method of manufacturing smart fertilizers, comprising:
heating at a temperature of 25° C. to 35° C. and stirring at a speed of 100 rpm to 500 rpm a mixture of vegetable oil having a first percentage weight (% w) and a solvent having a second percentage weight (% w) for 1 hour to 2 hours;
dispersing nanocarbon material having a third percentage weight in said mixture using an ultrasonic proble having an electrical power of 2000 watts operated at a speed of 300 rpm for a duration from 3 minutes to 2 hours and at a temperature from 25° C. to 35° C.;
mixing said mixture with a nanocomposite hydrogel having a fourth percentage weight (% w/) and water so that said nanocomposite hydrogel is in a liquid form; and
mixing said nanocomposite hydrogel and functionalized nano carbon solution with a fertilizer having a fifth percentage weight (% w).

13. The method of claim 12 wherein said vegetable oil is selected from a linseed oil, a soybean oil, and a sunflower oil; wherein said first percentage weight is 0.5% to 5%.

14. The method of claim 12 wherein said solvent is selected from methanol, ethanol, and acetone; wherein said second percentage weight is 94% to 99%.

15. The method of claim 12 wherein said nanocarbon material is a carbon nanotube characterized by a plurality of nanotubes having a diameter ranged from 3 nm to 50 nm, by a plurality of layers ranged from 3 to 45 layers, and by a carbon content of at least 95%; wherein said third percentage weight is 0.005% to 1%.

16. The method of claim 12 wherein said nanocarbon material is a graphene sheet characterized by having a carbon content of at least 95%, a surface area ranged from 5 to 150 m²/g, at least 3 to 20 layers; wherein each layer has a thickness ranged from 5 nm to 100 nm.

17. The method of claim 12 wherein said nanocarbon material is nano carbon particle having a particle size ranged from 300 nm to 600 nm, preferably 400 nm to 550 nm.

18. The method of claim 12 wherein said first percentage weight (% w) is between 0.5% to 5%, said second percentage weight (% w) is between 94% to 99%, and said third percentage weight is between 0.005% to 1%.

19. A method of using a smart nanocarbon fertilizer, comprising:
(a) preparing a nanocarbon solution comprising a vegetable oil having a 0.5% to 5% percentage weight (% w), a solvent having a 94% to 99% percentage weight (% w); and a nanocarbon material having a 0.005% to 1% percentage weight (% w); wherein said vegetable oil is selected from linseed oil, soybean oil, and sunflower oil; wherein said solvent is selected from methanol, ethanol, and acetone; wherein
(b) frying a fertilizer in a rotating pan tilt at an angle of 30° to 60°, rotating at a speed of 10 to 50 rpm and at a temperature from 40° C. to 60° C.; wherein said fertilizer has a 10% to 30% percentage weight (% w);
(c) mixing said nanocomposite material with said nano carbon solution;
(d) spraying said nanocarbon solution and said nanocomposite hydrogel onto said fertilizer at a speed of 0.6-1.8 liter per hour to obtain a mixture of functionalized nanocarbon solution; and
(e) mixing said functionalized nano carbon solution with nanocomposite hydrogel
(f) drying said functionalized nanocarbon solution at 80° C. for 6 to 24 hours.

20. The method of claim 19 further comprising:
(g) distributing said smart fertilizer into surrounding soil;
(h) detecting pH of said surrounding soil;
(i) if said pH of said surrounding soil is less than a predetermined pH, collapsing said nanocomposite hydrogel to release said fertilizer; and
(j) if said pH of said surrounding soil is greater or equal to said predetermined pH, continuing to retain said fertilizer inside said nanocomposite hydrogel.
